(19) United States
(12) Patent Application Publication
(10) Pub. No.: US 2023/0041562 A1
(43) Pub. Date: Feb. 9, 2023

(54) IMPROVING USABILITY BY ADDING VOICE INFORMATION

(71) Applicant: HEWLETT-PACKARD DEVELOPMENT COMPANY, L.P., Spring, TX (US)

(72) Inventors: Yoon Soo LEE, Seongnam-si, Gyeonggi-do (KR); Ji Hyun YOON, Seongnam-si, Gyeonggi-do (KR); Tae Soon KIM, Seongnam-si, Gyeonggi-do (KR)

(21) Appl. No.: 17/793,081

(22) PCT Filed: Sep. 30, 2020
(86) PCT No.: PCT/US2020/053422

§ 371 Date: Jul. 15, 2022

(30) Foreign Application Priority Data
Apr. 27, 2020 (KR) 10-2020-0050922

(51) Int. Cl. H04N 1/00; H04N 1/32; G06F 3/16

(52) U.S. Cl. CPC H04N 1/00488; G06F 3/167; H04N 1/32128; H04N 2201/3264

(57) ABSTRACT

A method for controlling an image forming apparatus can include receiving page description language (PDL) data including print data of a document to be output, attribute data, of the document, and voice data of the document from an external apparatus. The method can include outputting the voice data of the received PDL data via a speaker.

### BACKGROUND

An image forming apparatus may refer to an apparatus which prints print data generated on a terminal apparatus such as a computer on a printing paper. Examples of such an image forming apparatus may include a copier, a printer, a facsimile, a multifunction peripheral (MFP) serving functions of these in combination with one apparatus, and the like.

### BRIEF DESCRIPTION OF THE DRAWINGS

FIG. 1 is a view of an example operation in which an image forming apparatus receives voice information via a server apparatus and outputs the received voice information according to an example;

FIG. 2 is a view of an example voice information output process and an example process of performing an image forming job according to an example of FIG. 1;

FIG. 3 is a view of an exampleoperation in which the image forming apparatus receives voice information from an external apparatus and outputs the received voice information according to an example;

FIG. 4 is a view of an examplevoice information output process and a process of performing an image forming job according to an example of FIG. 3;

FIG. 5 is a flowchart of a method for controlling the image forming apparatus according to an example;

FIG. 6 is a view of an example in which the image forming apparatus is selected based on output voice information according to an example;

FIG. 7 is a view of an example process in which the image forming apparatus performs an image forming job based on output voice information according to an example;

FIG. 8A is a view of an example of voice data in a text form according to an example;

FIG. 8B is a view of an example of voice data in an audio form according to an example;

FIG. 9 is an example timing chart of a process in which the image forming apparatus outputs voice information via a server apparatus and performs an image forming job according to an example;

FIG. 10 is an example timing chart of a process in which the image forming apparatus receives voice information from an external apparatus and performs an image forming job according to an example;

FIG. 11 is an example process of outputting voice information regarding a printing state according to an example;

FIG. 12 is a block diagram illustrating a configuration of the image forming apparatus according to an example; and

FIG. 13 is a block diagram illustrating a specific configuration of the image forming apparatus according to an example.

### DETAILED DESCRIPTION

Hereinafter, various examples will be described in detail with reference to the drawings. The examples described hereinafter may be modified and performed in various different aspects.

In the disclosure, the expression that a certain component is “connected” to another component includes a case where the components are “directly connected to each other”, and also a case where the components are “connected to each other with another component interposed therebetween”. In addition, the expression that a certain component “includes” another component may mean that other components are not excluded and the other components may be further included, unless otherwise noted.

In the disclosure, an “image forming apparatus” may refer to an apparatus which prints print data generated on a terminal apparatus such as a computer on a recording paper. Examples of such an image forming apparatus may include a copier, a printer, a facsimile, and a multi-function peripheral (MFP) serving functions of these in combination with one apparatus, among others.

In addition, an “image forming job” may refer to various jobs (e.g., printing, scanning, or faxing) relating to an image such as forming of an image or generating, saving, or transmitting of an image file, and the “job” may include the image forming job, and/or may include processes for performing the image forming job.

Further, “pull-printing” may refer to a series of methods for selecting an output menu by a user via an external apparatus and inputting authentication information on the image forming apparatus, and performing the image forming job by the image forming apparatus, for security of the image forming job. In some examples, the pull-printing may refer to a method for transmitting a print job to a server apparatus from an external apparatus and storing the received print job in the server apparatus. When the print job for performing a user authentication process and the image forming job is selected on the image forming apparatus, the method can include receiving the print job selected on the image forming apparatus from the server apparatus and performing the image forming job.

In addition, in some examples the pull-printing may refer to a method for transmitting the print job from an external apparatus to a plurality of image forming apparatuses by a multicasting or broadcasting method. For instance, when the print job for performing a user authentication process is selected and the image forming job is selected on the image forming apparatus, the method can include performing the image forming job regarding the print job selected on the image forming apparatus.

The “print job” may refer to document data which is a target of the image forming job and/or additional data.

A “voice data” may refer to data output as a sound from the image forming apparatus. The voice data may be data which is transmitted to the image forming apparatus directly or via a server apparatus together with the print job from the external apparatus. In some examples, the voice data may be data which is stored in the image forming apparatus and output as a sound in response to an operation of the image forming apparatus. In addition, in some examples, the voice data transmitted to the image forming apparatus from the external apparatus may be data in an audio format or data in a text type.

A “print data” may refer to data converted into a format to be printed on a printer. If the printer supports direct printing, the file itself may be the print data.

A “user” may refer to a person who performs manipulation of the image forming apparatus using the image forming apparatus or using a device connected to the image forming apparatus in a wired or wireless manner.

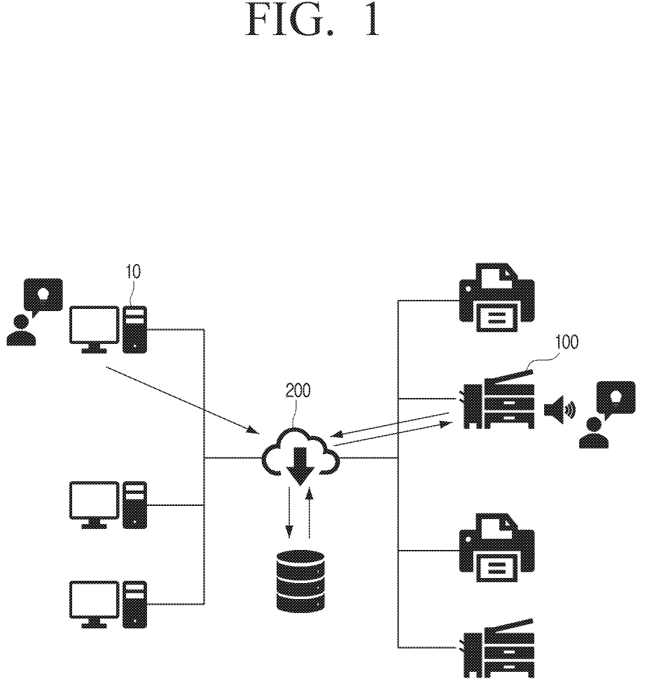

FIG. 1 is a view of an example operation in which an image forming apparatus 100 receives voice information via a server apparatus 200 and outputs the received voice information according to an example.

FIG. 1 illustrates an external apparatus 10, a server apparatus 200, and an image forming apparatus 100. The external apparatus 10 may be connected to the server apparatus 200 and the server apparatus 200 may be connected to the image forming apparatus 100. The number of the external apparatuses and the image forming apparatuses may be more than one. In other words, the plurality of external apparatuses may be connected to the server apparatus 200 and the server apparatus 200 may be connected to the plurality of image forming apparatuses.

In some examples, a user may generate a file on the external apparatus 10 and input an image forming job command regarding the generated file. The external apparatus 10 which receives the image forming job command from the user may transmit a print job to the server apparatus 200. For example, the print job may include the generated file and additional data. The generated file may be print data, and the additional data may include attribute data, and/or voice data, among others. For example, the voice data may be data extracted from the generated file or attribute data. In this case, the voice data may be data in a text form. In some examples, the voice data may be data recorded by the user in relation to the file. In this case, the voice data may be data in an audio format. In some instances, the voice data may be data obtained by converting the data in an audio format into data in a text form.

The external apparatus 10 may transmit user information. The server apparatus 200 may store the received print job in a memory. The server apparatus 200 may store the received print job to correspond to the user information based on the received user information. The server apparatus 200 may extract voice data from the stored print job.

A user may input authentication information on the image forming apparatus 100. For example, the authentication information may include identification information, information stored in a password or an authentication card, and the like. The image forming apparatus 100 may pull the print job from the server apparatus 200, if the input authentication information is authentication information of a user who has output authority. In some examples, the image forming apparatus 100 may pull the extracted voice data first from the server apparatus 200.

In some instances of pulling the extracted voice data first from the server apparatus 200, the image forming apparatus 100 may output the voice data pulled from the server apparatus 200 as a sound. For example, the voice data may be data in a text form. If the voice data is data in a text form, the image forming apparatus 100 may obtain voice data by converting a text into a voice using a text-to-speech (TTS) function. The image forming apparatus 100 may output the obtained voice data as a sound via a speaker. In some examples, the voice data may be data in an audio format. If the voice data is data in an audio format, the image forming apparatus 100 may output the data in an audio format as a sound via the speaker. The user, in some examples, may listen to the additional information of the file output as a sound and select a file for performing the image forming job. The image forming apparatus 100 may pull the selected file from the server apparatus 200 and then perform the image forming job, for instance.

In some examples, the server apparatus 200 may store the received print job to correspond to the user information, and the image forming apparatus 100 may pull the print job stored to correspond thereto, based on input authentication information and user information. The print job pulled by the image forming apparatus 100 may include the extracted voice data. In some examples, the image forming apparatus 100 may output the extracted voice data as a sound. Similarly, as described above, if the voice data is data in a text form, the image forming apparatus 100 may convert a text into voice data using a TTS function and output the converted voice data as a sound. In some examples, if the voice data is data in an audio format, the image forming apparatus 100 may output the data in an audio format as a sound. The user may listen to the additional information of the file output as a sound and select a file for performing the image forming job. The image forming apparatus 100 may perform the image forming job of the selected file.

In some examples, if the user inputs the authentication information on the image forming apparatus 100, the image forming apparatus 1C10 may pull the print job from the server apparatus 200. The image forming apparatus 100 may extract voice data from the pulled print job. If the voice data is data in a text form, the image forming apparatus 100 may obtain voice data by converting a text into a voice using the text-to-speech (TTS) function. The image forming apparatus 100 may output the obtained voice data as a sound via the speaker. In some examples, if the voice data is data in an audio format, the image forming apparatus 100 may output the data in an audio format as a sound via the speaker.

The user may listen to the additional information of the file output as a sound and select a file for performing the image forming job. The image forming apparatus 100 may perform an image forming job of the selected file in some instances.

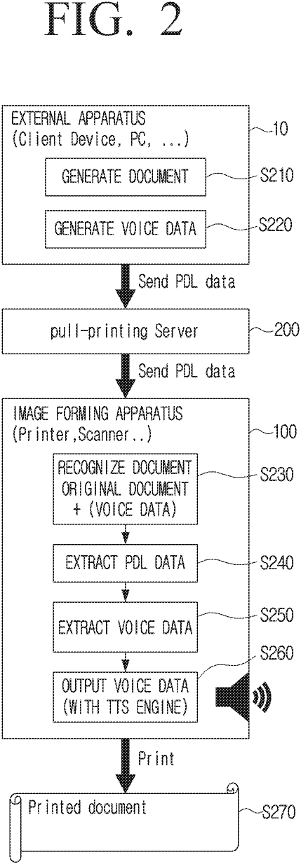

FIG. 2 is a view of an example voice information output process and an example process of performing an image forming job according to an example of FIG. 1.

Referring to FIG. 2, the user may generate a document on the external apparatus 10 (S210). The external apparatus 10 may generate voice data based on a generated document (S220). The voice data may include data recorded by the user in relation to the document. For example, the voice data may include first voice data regarding attribute data of the document and second voice data regarding a content of the document. The first voice data, for instance, may include document name information, document writer information, page number information, document size information, number of printed sheets information, color information, one-sided printing information, font information, file direction information, file format information, etc. The second voice data may include, for instance, document content title information, document content summary information, information of a document content recorded by a document user, etc. When a document is generated on the external apparatus 10, the attribute data of the document and data regarding a content of the document may be extracted from the generated document. The extracted attribute data of the document and data regarding a content of the document may be respectively generated as first and second voice data in a text form to be output as a sound from the image forming apparatus 100.

In some examples, when an image forming job command for the generated document is received from the user, the external apparatus 10 may generate page description language (PDL) data including print data of the document, attribute data of the document, and voice data of the document. The external apparatus 10 may transmit the PDL data to the server apparatus 200. The voice data may be inserted into an empty area of the PDL data or added to a tail area of the PDL data and transmitted. For example, the PDL data may include a printer command language (PCL), and/or postscript (PS), among others. In some examples, the external apparatus 10 may transmit user information to the server apparatus 200. The server apparatus 200 may match the received PDL data with the user information based on the user information received from the external apparatus 10 and store these in the memory.

In some examples, the user may input authentication information to any image forming apparatus 100. When a user inputs authentication information on the image forming apparatus 100, the image forming apparatus 100 may pull a print job matched with the corresponding user information based on the authentication information input from the server apparatus 200 and may recognize the print job (e.g., document) for performing the image forming job (S230).

In some instances, the image forming apparatus 100 may extract PDL data from the print job pulled from the server apparatus 200 (S240). In some examples, the PDL data may include print data of a document,attribute data of the document, and voice data of the document.

In some examples, the image forming apparatus 100 may extract the voice data from the PDL data (S250). The voice data may be data in a text form or data in an audio format. The image forming apparatus 100 may output the voice data in a text form as a sound via the speaker using the TTS function (S260). In some instances, the image forming apparatus 100 may output the data in an audio format as a sound via the speaker.

For example, the image forming apparatus 100 may output information included in first voice data or second voice data as a sound so that the user may select a document for performing the image forming job. When the user selects a document for performing the image forming job, the image forming apparatus 100 may perform the image forming job regarding the print data of the selected document (S270). In some instances, the voice data output as a sound when the image forming apparatus 100 performs the image forming job may include third and fourth voice data, in addition to the first and second voice data described above. For example, the third voice data may be voice data regarding a printing state on an image forming apparatus and the fourth voice data may be voice data guiding a voice input for selecting a print option. The image forming apparatus 100 may output the third voice data regarding the printing state as a sound via the speaker. In some examples, the third voice data may be stored as voice data in a text form or data in an audio format in a memory of the image forming apparatus. For example, the third voice data may include the total number of print data pieces of the document, order information of the currently selected print data, and the like.

In some examples, the image forming apparatus may output the fourth voice data guiding a voice input for selecting the print option based on the received voice data as a sound via the speaker. The fourth voice data may be stored as voice data in a text form or data in an audio format in the memory of the image forming apparatus, in some instances. Anexample in which the image forming apparatus outputs the voice data as a sound is described below.

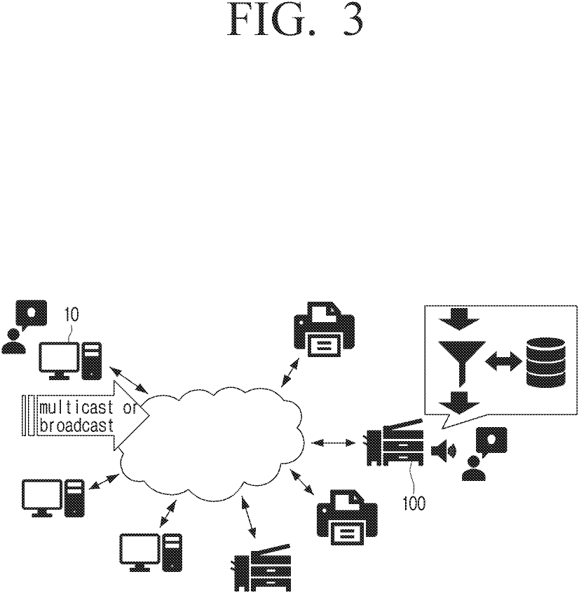

FIG. 3 is a view of an example operation in which the image forming apparatus 100 receives voice information from the external apparatus 10 and outputs the received voice information according to an example.

Referring to FIG. 3, the external apparatus 10 and the image forming apparatus 100 are illustrated. The external apparatus 10 may be directly connected to the image forming apparatus 100. In some examples, the number of the external apparatuses and the image forming apparatuses may be more than one. In other words, the plurality of external apparatuses may be connected to the plurality of image forming apparatuses.

In some examples, a user may generate a file on the external apparatus 10 and input an image forming job command regarding the generated file. The external apparatus 10 which receives the image forming job command from the user may transmit a print job to the image forming apparatus 100. For example, the external apparatus 10 may transmit the print job to some or all of the image forming apparatuses connected in a broadcasting or a multicasting method. In some examples, the external apparatus 10 may directly transmit the print job to a specific image forming apparatus. Each of the image forming apparatuses includes a memory and each of the image forming apparatuses may store the received print job in the memory. The external apparatus 10 may transmit the user information in some instances. The image forming apparatus 100 may store the received print job to correspond to the user information based on the received user information.

For example, the print job may include the generated file and additional data. The generated file may be print data, and the additional data may include attribute data, voice data, etc. For example, the voice data may be data extracted from the generated file or attribute data. In such an example, the voice data may be data in a text form. In some instances, the voice data may be data recorded by the user in relation to the file. In such examples, the voice data may be data in an audio format. The voice data may be data obtained by converting the data in an audio format into data in a text form in some examples.

In some instances, if the user inputs the authentication information on the image forming apparatus 100, the image forming apparatus 100 may extract the voice data from the stored print job. If the voice data is data in a text form, the image forming apparatus 100 may obtain voice data by converting a text into a voice using the text-to-speech (TTS) function. The image forming apparatus 100, in some examples, may output the obtained voice data as a sound via the speaker. In some instances, if the voice data is data in an audio format, the image forming apparatus 100 may output the data in an audio format as a sound via the speaker. The user may listen to the additional information of the file output as a sound and select a file for performing the image forming job. The image forming apparatus 100 may perform an image forming job of the selected file, in some examples.

In examples in which the number of image forming apparatuses is more than one and one image forming apparatus 100 performs the image forming job, the image forming apparatus 100 which has performed the image forming job may notify that the image forming job has performed to the external apparatus 10 or other image forming apparatuses 100 by a broadcasting method or a multicasting method.

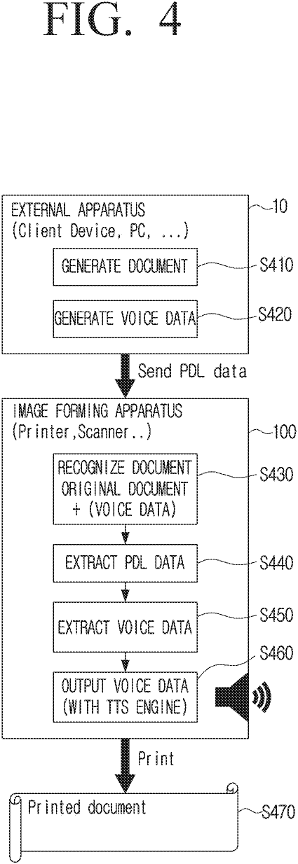

FIG. 4 is a view of an examplevoice information output process and a process of performing an image forming job according to an example of FIG. 3.

Referring to FIG. 4, the user may generate a document on the external apparatus 10 (S410). The external apparatus 10 may generate voice data based on a generated document (S420). For example, the voice data may include first voice data regarding attribute data of the document and second voice data regarding a content of the document. The first voice data may include, in some examples, document name information, document writer information, page number information, document size information, number of printed sheets information, color information, one-sided printing information, font information, file direction information, file format information, etc. The second voice data may include, in some examples, document content title information, document content summary information, information of a document content recorded by a document user, etc.

In some examples, when an image forming job command for the generated document is received form the user, the external apparatus 10 may generate PDL data including print data of the document, attribute data of the document, and voice data of the document. The PDL data may be transmitted to the image forming apparatus 100 by the external apparatus 10. For example, the PDL data may include a printer command language (PCL), and/or postscript (PS), among others. In some examples, the external apparatus 10 may transmit user information to the image forming apparatus 100. The image forming apparatus 100 may match the received PDL data with the user information based on the user information received from the external apparatus 10 and store these in the memory.

The user may input authentication information to any image forming apparatus. In some examples, when a user inputs authentication information on the image forming apparatus, the image forming apparatus may recognize the print job (e.g., document) matched with the corresponding user information based on the input authentication information (S430).

The image forming apparatus 100 may extract PDL data from the recognized print job (S440). In some examples, the PDL data may include print data of a document and attribute data and voice data of the document.

The image forming apparatus 100 may extract the voice data (S450) in some examples. The voice data may be data in a text form or data in an audio format. The image forming apparatus 100 may output the voice data in a text form as a sound via the speaker using the TTS function (S460). In some examples, the image forming apparatus may output the data in an audio format as a sound via the speaker.

For example, the image forming apparatus 100 may output information included in first voice data or second voice data as a sound so that the user may select a document for performing the image forming job. When the user selects a document for performing the image forming job, the image forming apparatus 100 may perform the image forming job regarding the print data of the selected document (S470). In some examples, the voice data output as a sound when the image forming apparatus performs the image forming job may include third and fourth voice data, in addition to or alternative to the first and second voice data described above. For example, the third voice data may be voice data regarding a printing state on an image forming apparatus and the fourth voice data may be voice data guiding a voice input for selecting a print option. The image forming apparatus 100, in some examples, may output the third voice data regarding the printing state as a sound via the speaker. The third voice data may be stored as voice data in a text form or data in an audio format in a memory of the image forming apparatus. For example, the third voice data may include the total number of print data pieces of the document and/or order information of the currently selected print data, among others.

The image forming apparatus may output the fourth voice data guiding a voice input for selecting the print option based on the received voice data as a sound via the speaker in some examples, The fourth voice data may be stored as voice data in a text form or data in an audio format in the memory of the image forming apparatus.

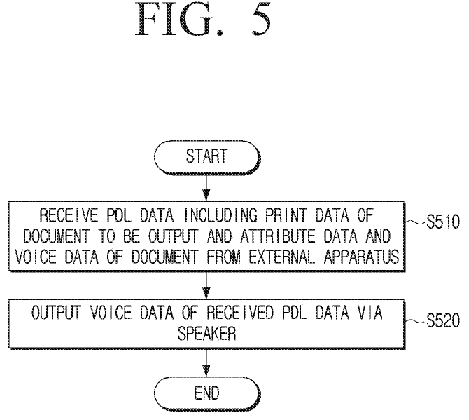

FIG. 5 is a flowchart of a method for controlling the image forming apparatus according to an example.

Referring to FIG. 5, the image forming apparatus may receive a PDL data including print data of a document to be output and attribute data and voice data of the document from the external apparatus (S510). In some examples, the image forming apparatus may receive the PDL data from the external apparatus via the server apparatus. In some instances, the image forming apparatus may directly receive the PDL data from the external apparatus. The received voice data may include first voice data regarding attribute data of the document and second voice data regarding a content of the document. In some examples, the image forming apparatus may store third voice data regarding a printing state or fourth voice data guiding a voice input for selecting a print option based on the received voice data. The voice data may be data in a text form or data in an audio format.

In some examples, he image forming apparatus may output the voice data of the received PDL data via the speaker (S520). The image forming apparatus may output the first voice data, the second voice data, and the third voice data regarding the printing state of the image forming apparatus performing the printing, based on the received voice data as a sound via the speaker. For example, the first voice data may include document name information, document writer information, page number information, document size information, number of printed sheets information, color information, one-sided printing information, font information, file direction information, file format information, etc. The second voice data may include document content title information, document content summary information, information of a document content recorded by a document user, etc. The third voice data may include the total number of print data pieces of the document, order information of the currently selected print data, etc.

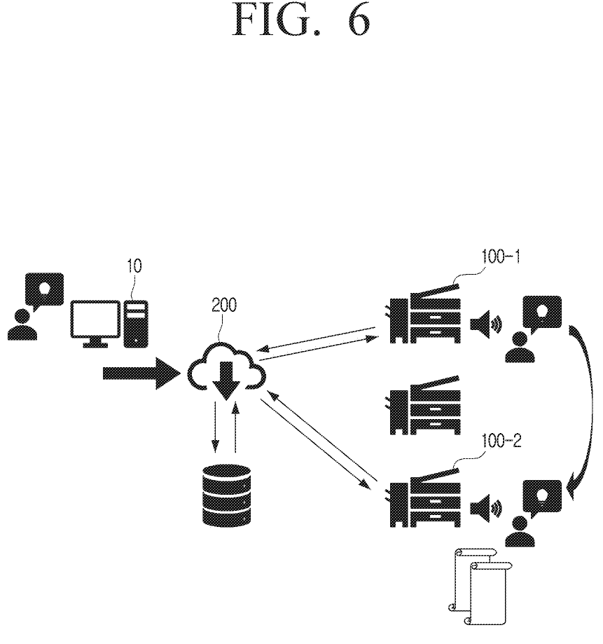

FIG. 6 is a view of an example in which the image forming apparatus 100-1, 100-2 is selected based on output voice information according to an example.

FIG. 6 illustrates the external apparatus 10, the server apparatus 200, a plurality of image forming apparatuses 100-1 and 100-2. FIG. 6 illustrates an example in which the print job is transmitted from the external apparatus 10 to the image forming apparatuses 100-1 and 100-2 via the server apparatus 200. For example, the first image forming apparatus 100-1 may be a black and white printer and the second image forming apparatus 100-2 may be a color printer.

The user may input a print command to the external apparatus 10 to generate a document A and print the document A on the image forming apparatus. In some examples, the external apparatus 10 may transmit the print job to the server apparatus 200 in accordance with the print command of the user. The server apparatus 200 may store the received print job. For example, the print job may include print data of a document and attribute data and voice data of the document. In some examples, the external apparatus 10 may extract attribute data of “containing color content” from the document A, and generate voice data of “containing color content” in a text form based on the extracted attribute data. The server apparatus 200 may extract the voice data from the received print job of the document A. In addition, the voice data may be extracted by the image forming apparatus (e.g., 100-1, 100-2).

In some examples, the user may input authentication information to the first image forming apparatus 100-1 to print the document A on the first image forming apparatus 100-1. If the authentication information is authentication information of a user who has print authority, the first image forming apparatus 100-1 may receive the extracted voice data from the server apparatus 200. The first image forming apparatus 100-1 may convert the received voice data in a text form into a voice using the TTS function. In some instances, the image forming apparatus 100-1 may output the voice data of “containing color content” via the speaker. The user may listen to the output voice data and check ability of a color print job of the first image forming apparatus 100-1. If the user recognizes that the first image forming apparatus 100-1 is a black and white printer, the user may proceed the image forming job on the second image forming apparatus 100-2 capable of performing the color print job.

In some examples, the first image forming apparatus 100-1 may output the voice data of “This printer is a black and white printer” for the user as a sound via the speaker based on the voice data included in the print job of the document A. In other words, the first image forming apparatus 100-1 may determine that the document A includes a color content from the voice data received from the server apparatus 200. In some examples, the first image forming apparatus 100-1 may store the voice data of “This printer is a black and white printer” in a memory of the first image forming apparatus 100-1. If the stored voice data is voice data in a text form, the first image forming apparatus 100-1 may output information of “This printer is a black and white printer” via the speaker by converting the voice data into a sound using the TTS function. In some examples, if the stored voice data is data in an audio format, the first image forming apparatus 100-1 may output information of “This printer is a black and white printer” via the speaker. If the user recognizes that the first image forming apparatus 100-1 is a black and white printer, the user may proceed the image forming job on the second image forming apparatus 100-2 capable of performing the color print job.

The example in which the PDL data is transmitted to the image forming apparatuses 100-1 and 100-2 via the server apparatus 200 has been described with reference to FIG. 6, but the PDL data may be directly transmitted to the image forming apparatuses 100-1 and 100-2 without passing through the server apparatus 200, as described above. As described above, the external apparatus 10 may directly transmit the PDL data to the image forming apparatuses 100-1 and 100-2 by a broadcasting method or a multicasting method. In some examples, the image forming apparatuses 100-1 and 100-2 may extract the voice data from the PDL data and output the voice data as a sound. The process of outputting the voice data as a sound and performing the image forming job by the image forming apparatuses 100-1 and 100-2 may be the same as the process described in FIG. 6, and therefore the specific description will not be repeated.

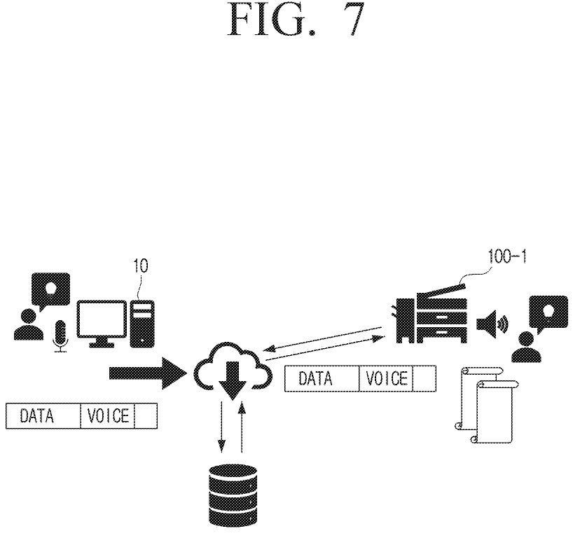

FIG. 7 is a view of an example process in which the image forming apparatus 100-1 performs an image forming job based on output voice information according to an example.

Referring to FIG. 7, the external apparatus 10 may insert the voice data to the PDL data. In some examples, the voice data recorded by the user may be inserted to an empty area in a predetermined range of the PDL data or may be added to a tail area of the PDL data. For example, the voice data recorded by the user may be data in an audio format or may be data obtained by converting the data in an audio format into a text form.

In some examples, the PDL data including the voice data recorded by the user may be transmitted to the server apparatus 200 and stored in the server apparatus 200. The server apparatus 200 may extract the voice data recorded by the user from the stored PDL data. When the user inputs authentication information on the image forming apparatus 100-1, the image forming apparatus 100-1 may receive voice data from the server apparatus 200. In some instances, the image forming apparatus 100-1 may output the received voice data as a sound via the speaker. The image forming apparatus 100-1 may output the data in an audio format directly as a sound and output the voice data in a text form by converting the voice data in a text form into a voice using the TTS function. In some examples, the voice data recorded by the user may include the data, “Note: This should be printed with color printer and handed out to each person by two copies”. The image forming apparatus 100-1 may output the extracted information of “Note: This should be printed with color printer and handed out to each person by two copies” transmitted by the server apparatus 200 as a sound.

In some examples, the user may proceed the image forming job on the current image forming apparatus 100-1 or may proceed the image forming job on the other image forming apparatus based on the information output as a sound.

The example in which the PDL data is transmitted to the image forming apparatus 100-1 via the server apparatus 200 has been described with reference to FIG. 7, but the PDL data may be directly transmitted to the image forming apparatus 100-1 without passing through the server apparatus 200, as described above. As described above, the external apparatus 10 may directly transmit the PDL data to the image forming apparatuses 100-1 and 100-2 by a broadcasting method or a multicasting method. In some examples, the image forming apparatuses 100-1 and 100-2 may extract the voice data from the PDL data and then output the voice data as a sound. The process of outputting the voice data as a sound and performing the image forming job by the image forming apparatuses 100-1 and 100-2 may be the same as the process described in FIG. 7, and therefore the specific description will not be repeated.

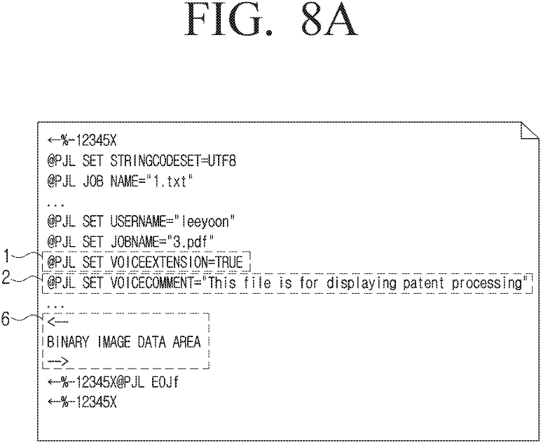

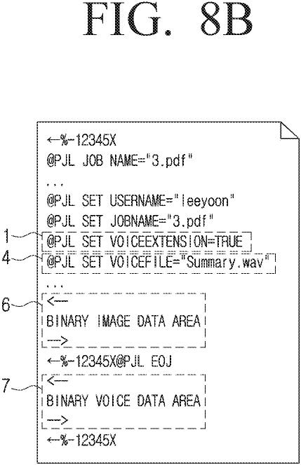

FIG. 8A is a view of an example of voice data in a text form according to an example and FIG. 8B is a view of an example of voice data in an audio form according to an example.

In some examples, when the image forming apparatus receives the PDL data including voice data to be output using TTS function, the image forming apparatus may receive the PDL data as in the example illustrated in FIG. 8A. A front part of the PDL data may include attribute information of a document. In some examples, if the PDL data includes voice data to be output using the TTS function, the attribute of VOICE EXTENSION can be set as TRUE (1). As illustrated in FIG. 8A, the attribute of VOICE COMMENT may include voice data to be output using TTS function such as “This file is for displaying patent processing” (2). In some examples, the PDL data may include a binary image data area 6 including print data which is a target of an image forming job below the attribute of VOICE COMMENT. The image forming apparatus may output the information of “This file is for displaying patent processing” as a sound using the TTS function by referring to the attribute of VOICE EXTENSION and attribute of VOICE COMMENT of the received PDL data.

In some examples, he image forming apparatus may receive the PDL data including the voice data in an audio format. For example, the audio format may include formats such as wav, pcm, mp3, etc. The image forming apparatus may receive the PDL data as in the example illustrated in FIG. 8B. In some examples, the front part of the PDL data may include attribute information of a document. If the PDL data includes voice data in an audio format, the attribute of VOICE EXTENSION can be set as TRUE (1). As illustrated in FIG. 8B, the attribute of VOICE FILE may include a voice data file name such as “Summary.wav” (4). In some examples, the PDL data may include a binary image data area 6 including print data which is a target of an image forming job and a binary voice data area 7 including voice data in an audio format below the attribute of VOICE FILE. The image forming apparatus, in some instances, may output the information of the binary voice data area as a sound by referring to the attribute of VOICE EXTENSION and attribute of VOICE FILE of the received PDL data.

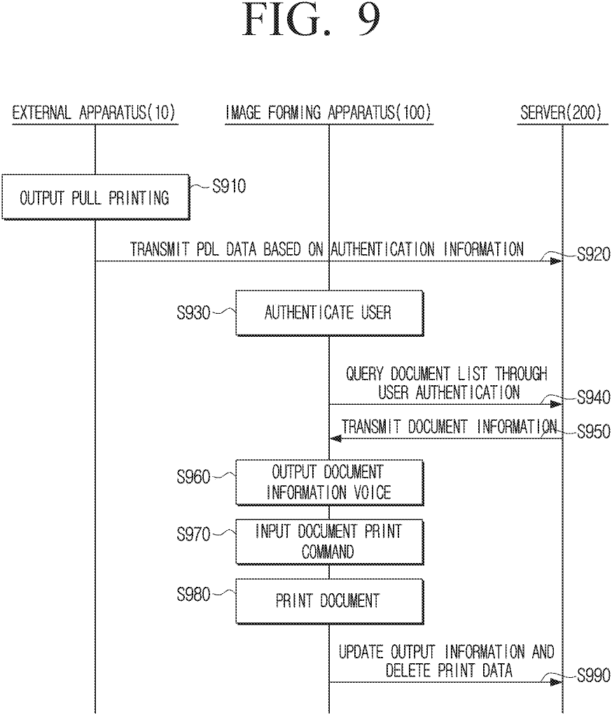

FIG. 9 is an example timing chart of a process in which the image forming apparatus 100 outputs voice information via a server apparatus 200 and performs an image forming job according to an example.

Referring to FIG. 9, the user may generate a document and input a pull printing output command on the external apparatus 10 (S910). For example, the external apparatus 10 may receive the pull printing output command from the user.

In some examples, the external apparatus may transmit the PDL data to the server apparatus 200 based on authentication information (S920). The PDL data transmitted to the server apparatus 200 may be matched with the authentication information and stored in the memory of the server apparatus 200, in some instances. For example, the PDL data may include print data, attribute data of the document, and voice data of the document. The voice data may include first voice data regarding attribute data of the document and include second voice data regarding a content of the document. In some examples, the first and second voice data may be extracted by the external apparatus 10 based on the document generated before the PDL data is transmitted to the server apparatus 200 from the external apparatus 10 or the print option set by the user and may be inserted or added to the PDL data. The first voice data may include, in some examples, document name information, document writer information, page number information, document size information, number of printed sheets information, color information, one-sided printing information, font information, file direction information, file format information, etc. The second voice data may include, in some instances, document content title information, document content summary information, information of a document content recorded by a document user, etc. The server apparatus 200 may extract voice data from the PDL data.

In some examples, the image forming apparatus 100 may receive authentication information from the user (S930). The image forming apparatus 100 may query a document list from the server apparatus 200 through user authentication (S940). For example, the authentication information may include identification information, information stored in a password or an authentication card, and the like. In some examples, the image forming apparatus 100 may query document list information from the server apparatus 200 if the input authentication information is authentication information of the user who has output authority.

In some examples, the server apparatus 200 may transmit the document information to the image forming apparatus 100 (S950). The image forming apparatus 100 may output the document information as a sound (S960) in some examples. In some examples, the document information transmitted from the server apparatus 200 to the image forming apparatus 100 may be voice data. In an exampleof the voice data being in a text form, the image forming apparatus 100 may output the voice data as a sound by converting the voice data into a voice using the TTS function. In an example of the data being in an audio format, the image forming apparatus 100 may output the audio format itself. The user may select a document to be printed and input a print command.

In some instances, the image forming apparatus 100 may receive a document print command (S970). The image forming apparatus 100 may print the document (S980). The image forming apparatus 100 may output the third voice data regarding the printing state of the document as a sound. For example, the third voice data may include the total number of print data pieces of the document, order information of the currently selected print data, and the like.

The image forming apparatus, in some examples, may output the fourth voice data guiding a voice input for selecting the print option as a sound via the speaker based on the received voice data. The fourth voice data may additionally or alternatively be stored as voice data in a text form or data in an audio format in the memory of the image forming apparatus. The user may select the print option based on the fourth voice data on the image forming apparatus 100.

In some examples, the image forming apparatus 100 may transmit an output information update and print data deletion command to the server apparatus 200 (S990). The server apparatus 200 may update the output information and delete the print data, the image forming job of which has completed.

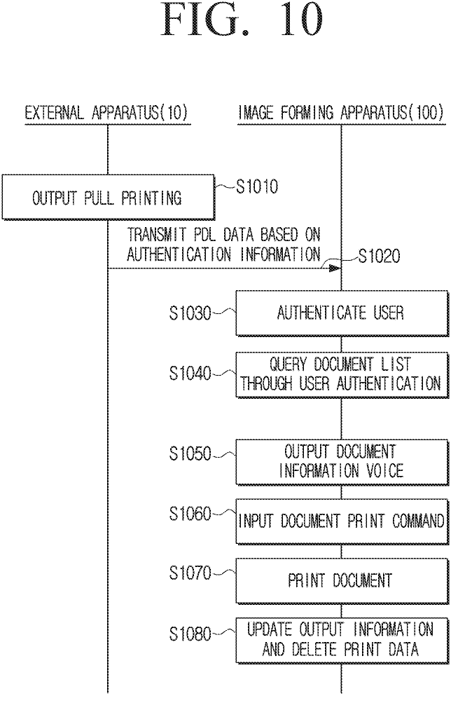

FIG. 10 is an example timing chart of a process in which the image forming apparatus 100 receives voice information from an external apparatus 10 and performs an image forming job according to an example.

Referring to FIG. 10, the user may generate a document and input a pull printing output command on the external apparatus 10 (S1010). For example, the external apparatus 10 may receive the pull printing output command from the user.

In some examples, the external apparatus 10 may transmit the PDL data to the image forming apparatus 100 based on authentication information (S1020). The PDL data transmitted to the image forming apparatus 100 may be matched with the authentication information and stored in the memory of the image forming apparatus 100. The image forming apparatus 100 may extract voice data from the received PDL data.

In some examples, the image forming apparatus 100 may receive authentication information from the user (S1030). When the user authentication is completed, the image forming apparatus 100 may obtain the document list (S1040). For example, the authentication information may include identification information, information stored in a password or an authentication card, etc. In some examples, the image forming apparatus 100 may obtain document list information if the input authentication information is authentication information of the user who has output authority.

The image forming apparatus 100, in some examples, may output the document information as a sound (S1050). In an example of the voice data being in a text form, the image forming apparatus 100 may output the voice data as a sound by converting the voice data into a voice using the TTS function. In an example of the data being in an audio format, the image forming apparatus 100 may output the audio format itself. The user may select a document to be printed and input a print command.

In some examples, the image forming apparatus 100 may receive a document print command (S1060). The image forming apparatus 100 may print the document (S1070). The image forming apparatus 100, in some instances, may output the third voice data regarding the printing state of the document as a sound. For example, the third voice data may include the total number of print data pieces of the document and/ororder information of the currently selected print data, among others.

The image forming apparatus 100 may output the fourth voice data guiding a voice input for selecting the print option as a sound via the speaker based on the received voice data in some examples. The fourth voice data may be stored as voice data in a text form and/or data in an audio format in the memory of the image forming apparatus. The user may select the print option based on the fourth voice data on the image forming apparatus 100.

In some examples, the image forming apparatus 100 may transmit an output information update and print data deletion command to the server apparatus 200 (S1080). The image forming apparatus 100 may update the output information and delete the print data, the image forming job of which has completed. In some examples, the image forming apparatus 100 may transmit a job completion notification to the external apparatus 10 and other image forming apparatuses.

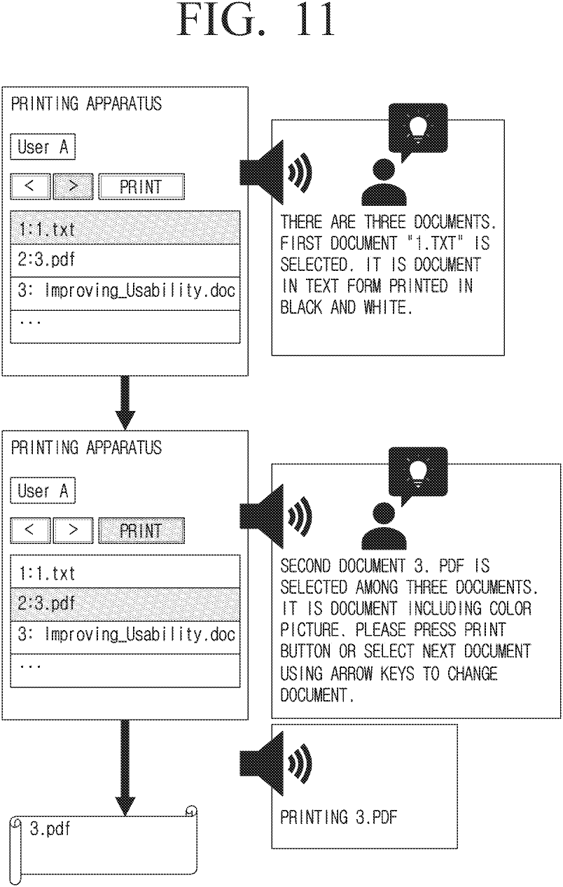

FIG. 11 is an example process of outputting voice information regarding a printing state according to an example.

Referring to FIG. 11, the image forming apparatus may receive authentication information from the user and display print data list information received from the server apparatus on a display. As described above, the external apparatus may transmit the PDL data to the server apparatus. In some examples, if the number of pieces of print data is more than one, the server apparatus may receive a plurality of pieces of PDL data and store these in the memory. The server apparatus may extract print data information from each PDL data and generate the print data list information including a plurality of pieces of print data information. In some instances, the server apparatus may extract voice data corresponding to each print data information from each PDL data. The server apparatus may transmit the generated print data list information and the voice data corresponding to each print data information to the image forming apparatus.

In some examples, the image forming apparatus may display the generated print data list information on the display and output the voice data corresponding to the currently selected print data information as a sound.

The user may select the next print data information. In some examples, the print forming apparatus may include an input device realized with arrow keys, a jog shuttle, etc. The user may select the next print data information of the currently selected print data information among the plurality of pieces of print data information through the arrow keys or the jog shuttle. In some examples, the user may continuously input a command through the arrow keys or the jog shuttle to skip at least one piece of print data information from the currently selected print data information and select specific print data information. The image forming apparatus, in some examples, may select the specific print data information corresponding to the input command of the user.

As illustrated in FIG. 11, if the user selects second print data information, the print forming apparatus may output voice data corresponding to the second print data information as a sound in some examples. If the user selects an output button, the image forming apparatus may receive print data corresponding to the selected print data information from the server apparatus in some instances. The image forming apparatus, in some examples, may print the second print data. The image forming apparatus may output the total number of pieces of print data of the document and the order information of the currently selected print data as a sound while printing the second print data in some examples.

The process in which the print data is transmitted from the external apparatus to the image forming apparatus via the server apparatus and output has been described with reference to FIG. 11, but the external apparatus may directly transmit the print data to the image forming apparatus without the server apparatus and output the print data. In such an example, the image forming apparatus may extract the print data information, the voice data, and the print data from the PDL data.

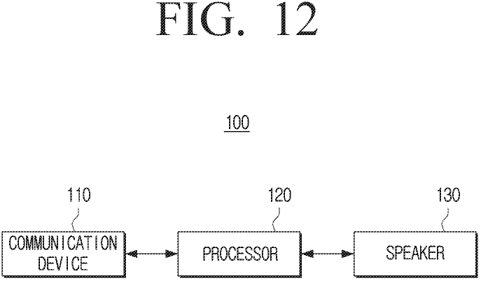

FIG. 12 is a block diagram illustrating a configuration of the image forming apparatus 100 according to an example.

Referring to FIG. 12, the image forming apparatus 100 may include a communication device 110, a processor 120, and a speaker 130.

The communication device 110, in some examples, may be formed to connect the image forming apparatus 100 to an external apparatus (not shown) or a server apparatus. The communication device 110 may alternatively or additionally be accessed through a universal serial bus (USB) port or a wireless communication (e.g., WiFi 802.11a/b/g/n, near field communication (NFC), or Bluetooth) port, in addition to local area network (LAN) and the Internet in some examples. The communication device 110 may refer to a transceiver.

The communication device 110, in some examples, may receive the PDL data from the server apparatus. In some examples, the communication device 110 may receive the print data list information and the voice data extracted from the server apparatus. The communication device 110 may directly receive the PDL data from the external apparatus, in some instances. For example, the external apparatus may include a desktop PC, a laptop computer, a smartphone, a tablet PC, etc.

In some examples, the user may generate a document on the external apparatus and record summary information of the generated document or user’s own information identifying the corresponding document. The external apparatus may extract voice data regarding an attribute and a content of the document from the generated document. In some instances, when the print command is input, the external apparatus may generate print data of the document, attribute data of the document, voice data regarding the attribute of the document and the content of the document, and voice data recorded by the user as the PDL data. The external apparatus may transmit the PDL data to the server apparatus. For example, the voice data may be inserted into an empty area of the PDL data or added to a tail area of the PDL data.

In some examples, the processor 120 may control general operations of the image forming apparatus 100. The processor 120 may output the print data by the pull printing method for security. For example, when receiving authentication information of the user who has output authority, the processor 120 may control the communication device 110 to receive document list information and voice data related to print data included in the document list information from the server apparatus. In some examples where the received voice data is in a text form, the processor 120 may convert the voice data into a sound using the TTS function. The processor 120 may control the image forming apparatus 100 to perform an image forming job process of outputting the received print data.

The speaker 130, in some examples, may output state information of the image forming apparatus 100 as a sound. For example, if the image forming apparatus 100 is in an error state, the speaker 130 may output a sound corresponding to the error state. In some instances, the speaker 130 may output the voice data converted into a sound or the voice data in an audio format.

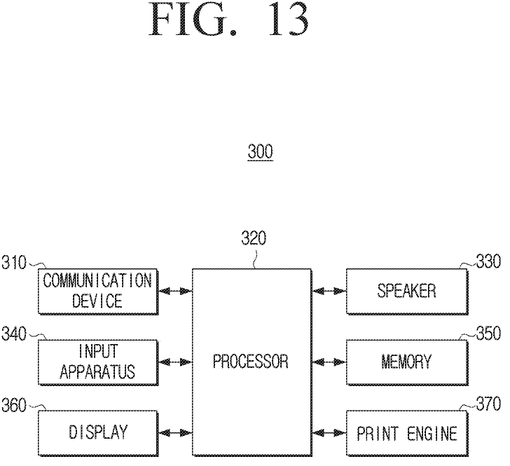

FIG. 13 is a block diagram illustrating a specific configuration of the image forming apparatus according to an example.

Referring to FIG. 13, an image forming apparatus 300 may include a communication device 310, a processor 320, a speaker 330, an input device 340, a memory 350, a display 360, and a print engine 370.

The communication device 310 and the speaker 330 may perform the same function as the communication device 110 and the speaker 130 of FIG. 12, respectively, and therefore the overlapped description is not repeated. The processor 320 may perform the similar function as the processor 120 of FIG. 12, and therefore the overlapped description regarding FIG. 12 is not repeated, and the contents related to the elements added to FIG. 13 are described below.

In some examples, the input device 340 may receive a function selection and a control command regarding the corresponding function from a user. The function may include a print function, a copy function, a scan function, and a fax transmission function, among others.

In some instances, the input device 340 may receive authentication information from the user. For example, the input device 340 may be implemented as a physical input device including a keypad, a keyboard, or a jog shuttle, or may be implemented in a form of a tagger for tagging a card storing authentication information. In some instances, the input device 340 may include a touch screen panel implemented with an output device displaying information.

In some examples, the input device 340 may receive an ID and a password from the user. The processor 320 may determine whether the input ID and password match with the authentication information stored in the memory 350. If the input ID and password match with the authentication information stored in the memory 350, for example, the processor 320 may determine that the user has output authority. Responsive to the processor 320 determining that the user has output authority, the processor 320 may control the image forming apparatus 300 to perform the image forming job process.

In some examples, if the number of print data pieces of the user is more than one, the input device 340 may receive a command for sequentially selecting the plurality of pieces of print data from the user. For example, the input device 340 may include arrow keys or a jog shuttle. When the user sequentially presses the arrow keys or spins the job shuttle, for example, the processor 320 may sequentially select the plurality of pieces of print data in response to the number of times of inputs of the arrow keys or an angle of the jog shuttle.

In some examples, the memory 350 may store at least one instruction regarding the image forming apparatus 300. For example, the memory 350 may store various programs (e.g., software) for operating the image forming apparatus 300 according to the various examples of the disclosure. In some examples, the memory 350 may store the authentication information of the user who has output authority of the image forming apparatus 300. For example, the authentication information may include identification information, information stored in a password or an authentication card, and the like.

In some examples, the processor 320 may control general operations of the image forming apparatus 300. For example, the processor 320 may generally control the operations of the image forming apparatus 300 by executing at least one instruction stored in the memory 350. In addition, the processor 320 may store the PDL data received from the server apparatus or the voice data and the attribute data of the document extracted and transmitted by the server apparatus in the memory 350. The processor 320 may output the print data by the pull printing method for security. For example, when receiving the authentication information of the user who has output authority, the processor 320 may control the image forming apparatus 300 to perform the image forming job process of receiving the print data from the server apparatus and outputting the print data.

In some examples, the display 360 may display a user interface window for receiving selection of a function supported by the image forming apparatus 300. For example, the display 360 may display the user interface window for receiving selection of various functions provided by the image forming apparatus 300. In some examples, the display 360 may be a monitor such as a liquid crystal display (LCD), a cathode ray tube (CRT), or an organic light emitting diodes (OLED), among others, and may be implemented as a touch screen to perform the function of the input device 340 at the same time.

In some examples, the print engine 370 may generate an image. For example, the print engine 370 may print a print image generated by the processor 320 on a printing paper. The print engine 370 may perform the printing by an electrophotography method or an ink jet method. In some examples, the print engine 370 may be a monochrome print engine capable of printing one color or a color print engine capable of performing color printing. In some instances, when the print data is received via the communication device 310, the processor 320 may control the print engine 370 so that the received print data is printed. In some examples, when a print command is received form the user, the processor 320 may control the print engine 370 so that the received print data is printed.

A method for adding and outputting the voice information described above may be implemented as a program and provided to the image forming apparatus. In particular, a program including the method for adding and outputting the voice information may be stored in a non-transitory computer readable medium.

In some examples, the non-transitory computer readable medium may not be a medium storing data for a short period of time such as a register, a cache, or a memory, but can refer to a medium that semi-permanently stores data and is readable by a machine. For example, the various applications or programs described above may be stored and provided in the non-transitory computer readable medium such as a CD, a DVD, a hard disk, a Blu-ray disc, a USB, a memory card, or a ROM. While some examples of the disclosure have been shown and described, the disclosure is not limited to the aforementioned specific examples, and modifications can be made without departing from the gist of the disclosure as claimed by the appended claims. Also, it is intended that such modifications are not to be interpreted independently from the technical idea or prospect of the disclosure.

What is claimed is:

1. A method for controlling an image forming apparatus, the method comprising:
receiving page description language (PDL) data comprising print data of a document to be output, attribute data of the document, and voice data of the document from an external apparatus; and
outputting the voice data of the received PDL data via a speaker.

2. The method according to claim 1, wherein receiving the voice data comprises receiving voice data included in a voice comment attribute or a binary voice data area of the PDL data.

3. The method according to claim 1, wherein receiving the voice data comprises receiving first voice data regarding the attribute data of the document and second voice data regarding a content of the document.

4. The method according to claim 3, wherein the outputting comprises outputting the first voice data, the second voice data, and third voice data regarding a printing state of the image forming apparatus performing the printing as a sound via the speaker based on the received voice data.

5. The method according to claim 4, wherein outputting the first voice data comprises outputting at least one of document name information, document writer information, page number information, document size information, number of printed sheets information, color information, one-sided printing information, font information, file direction information, or file format information.

6. The method according to claim 4, wherein outputting the second voice data comprises at least one of outputting document content title information, document content summary information, or information of a document content recorded by a document user.

7. The method according to claim 4, wherein outputting the third voice data comprises outputting a total number of print data pieces of the document and order information of currently selected print data.

8. The method according to claim 1, comprising:
outputting fourth voice data guiding a voice input for selecting a print option based on the received voice data.

9. An image forming apparatus comprising:
a communication device to receive data from an external apparatus;
a speaker; and a processor to
receive page description language (PDL) data comprising print data of a document to be output, attribute data of the document, and voice data of the document from the external apparatus via the communication device; and
output the voice data of the received PDL data via the speaker.

10. The apparatus according to claim 9, wherein the voice data is included in a voice comment attribute or a binary voice data area of the PDL data.

11. The apparatus according to claim 9, wherein the received voice data comprises first voice data regarding the attribute data of the document and second voice data regarding a content of the document.

12. The apparatus according to claim 11, further comprising the processor to output the first voice data, the second voice data, and third voice data regarding a printing state of the image forming apparatus performing the printing as a sound via the speaker based on the received voice data.

13. The apparatus according to claim 9, further comprising the processor to output fourth voice data guiding a voice input for selecting a print option based on the received voice data.

14. A non-transitory computer readable medium encoded with instructions executable by a processor, the computer readable medium comprising:
instructions to receive page description language (PDL) data comprising print data of a document to be output, attribute data of the document, and voice data of the document from an external apparatus; and
instructions to output the voice data of the received PDL data via a speaker.

15. The non-transitory computer readable medium according to claim 14, wherein the voice data is included in a voice comment attribute or a binary voice data area of the PDL data.
